(19) United States
(12) Patent Application Publication
(10) Pub. No.: US 2026/0227293 A1
(43) Pub. Date: Aug. 6, 2026

(54) METHODS AND SYSTEMS RELATED TO AGROCHEMICAL APPLICATION

(71) Applicant: SYNGENTA CROP PROTECTION AG, Basel (CH)

(72) Inventors: Raymond Joseph WUERFFEL, Greensboro, NC (US); Gabriele CHIAPPETTA, Basel (CH); Lucas FRANCA, Basel (CH); Tim POWELL, Bracknell, Berkshire (GB); Simon CALDWELL, Bracknell, Berkshire (GB)

(73) Assignee: SYNGENTA CROP PROTECTION AG, Basel (CH)

(21) Appl. No.: 19/148,479

(22) PCT Filed: Jan. 19, 2024
(86) PCT No.: PCT/US2024/012117

§ 371 Date: Jul. 16, 2025

Related U.S. Application Data
(60) Provisional application No. 63/480,762, filed on Jan. 20, 2023.

(51) Int. Cl. G01M 99/00; A01M 7/00

(52) U.S. Cl. CPC G01M 99/008; A01M 7/0096

(57) ABSTRACT

The present disclosure relates to methods and systems of spray calibration and measurement. The method including selecting a nozzle-agrochemical combination to perform at least one of reducing at least one of resistance development in a pest species, reducing phytotoxicity in a crop plant, maximizing effective dose, and reducing off target effects. The method may further include obtaining a target area having a target zone and an off-target zone and spraying for a time (T), a volume (V), of a liquid composition through a test nozzle, at a height (H) from the test nozzle to the target surface, and at the target zone of the target surface.

### CROSS-REFERENCE TO RELATED APPLICATIONS

This application claims the benefit of U.S. Provisional Patent Application Ser. No. 63/480,762, filed Jan. 20, 2023. The entire contents of which are incorporated by reference herein.

### TECHNICAL FIELD

The present invention relates to methods and systems for agrochemical application.

### BACKGROUND

To meet demand, modern agriculture relies on agrochemical compositions to protect and enhance crop growth. One common method of applying agrochemicals to help crops is by spraying the agrochemical composition to, e.g., a crop, a pest, or a locus of the crop. However, depending on the specific agrochemical composition being sprayed or ambient conditions, the droplet sizes of the sprayed agrochemical composition may vary. Unfortunately, when spray droplets are not appropriately calibrated, the droplets can move off-target. Off-target spraying can result increased agrochemical application and potential environmental damage. Accordingly, what applicant desires are methods and systems for calibrating droplet sizes of sprayed agrochemical compositions.

Furthermore, accuracy is critical when targeting a small spot versus broadcast applications (e.g. wind causing swath displacement). Most commercial spot spray systems use simple formulations (e.g., glyphosate, paraquat). These systems often utilize green-on-brown spraying which targets the desired crop, pest, or locus of the crop among fallow. However, new systems will need to spray complex mixtures in-crop that could impact application quality and the rate delivered to the target area. These systems often utilize green-on-green spraying which targets the desired crop, pest, or locus of the crop during the growing season. Accordingly, applicant further desires methods and systems for determining and reducing driftable, fine particles.

### SUMMARY

The present invention relates to a method of selecting a nozzle-agrochemical combination to perform at least one of reducing at least one of resistance development in a pest species, reducing phytotoxicity in a crop plant, maximizing effective dose, and reducing off target effects. The method may include obtaining a target area having a target zone and an off-target zone and spraying for a time (T), a volume (V), of a liquid composition through a test nozzle, at a height (H) from the test nozzle to the target surface, and at the target zone of the target surface. Further, the method may include measuring at least one of: the amount of the liquid composition in the target zone, and the amount of the liquid composition in the off-target zone; and producing a heat map of at least one of: the measured amount of the liquid composition in the target zone, and the measured amount of the liquid composition in the off-target zone.

In another aspect of the invention, the test nozzle moves parallel to the surface of the target surface. Further, the test nozzle may travel at a speed of 2 to 7 miles per hour and the spray height may be from 4 to 50 inches. Additionally, the target zone includes a triggering object such as a plant, a plant part, an object designed to mimic a plant or a plant part. In another aspect of the invention, detecting the triggering object within the target zone may trigger the spraying of the target area. Further, the target zone may have a surface area (TZSA) in the range of 4-200 cm² and an off-target zone may surround the target zone with a surface area of at least two times the TZSA. More preferably, the target zone may have a surface area in the range of 2 to 15 times the TZSA. Additionally, the target zone may include at least one layer of filter paper and the target area may include grid lines.

In another aspect of the invention, the liquid composition further comprises a visualization additive, such as an ultraviolet (UV) tracer dye. Other visualization additives including other dyes will be understood to a person of ordinary skill in the art. Further, measuring the amount of liquid composition may include quantifying the amount of UV tracer dye or other visualization additive in the off-target zone and/or the target zone. The target zone may also include a plurality of sub-target zones. Additionally, the method may be repeated with a second liquid test composition and/or with a different test nozzle as disclosed herein. Preferably, the second test composition may be identical to the composition except for the addition or removal of at least one adjuvant, such as a droplet control agent. Further, the method may include blowing air over the target surface. Finally, the method may include selecting a nozzle-chemical combination having at least one of a desired amount of the test chemical in the target zone, and a desired amount of the test chemical in the off-target zone.

Another aspect of the present invention relates to a method of spray calibration which may include first spraying an agrochemical composition from a fan sprayer and then determining from the spraying at least one of: a droplet size; surface tension; a formation and/or collapse of a fan angle; and a spray footprint. Preferably, the method may determine at least two of: a droplet size; surface tension; a formation and/or collapse of a fan angle; and a spray footprint. More preferably, the method may determine at least three of: a droplet size; surface tension; a formation and/or collapse of a fan angle; and a spray footprint. Even more preferably, the method may determine all of: a droplet size; surface tension; a formation and/or collapse of a fan angle; and a spray footprint.

Another aspect of the present invention relates to a method of spray calibration which may include first spraying an agrochemical composition from a jet sprayer and then determining from the spraying at least one of: droplet wetting on a leaf; a droplet size; surface tension; and droplet shatter or splash off. Preferably, the method may determine at least two of: droplet wetting on a leaf; droplet size; surface tension; and droplet shatter or splash off. More preferably, the method may determine at least three of: droplet wetting on a leaf; droplet size; surface tension; and droplet shatter or splash off. Even more preferably, the method may determine all of: droplet wetting on a leaf; droplet size; surface tension; and droplet shatter or splash off.

The method of the present invention can also include adjusting at least one component in the agrochemical composition to increase or decrease the droplet size of the sprayed agrochemical composition and/or include approving the agrochemical composition for spraying. The spraying may be employed as part of a tractor system or an aerial drone system. Additionally, the method of the present invention can include determining the droplet size by at least one of raindrop size distribution, volume median diameter, or any other means known to a person of ordinary skill in the art.

In another aspect of the invention, the agrochemical composition can contain a droplet control agent, which is the component(s) in the agrochemical composition used to increase or decrease the droplet size of the sprayed agrochemical composition. In another aspect of the invention, the method may include building a database of how the component(s) affects droplet size.

Further, in another aspect of the invention, the method may include measuring at least one ambient condition selected from temperature, humidity, noise level, air quality, light intensity, pressure, or other ambient condition known to a person of ordinary skill in the art. Preferably, the method may include measuring at least two, at least three, at least four, at least five, or all of the above ambient conditions.

Additionally, in another aspect of the invention, adjusting the at least one component in the agrochemical composition utilizes the database of how the ambient condition effects droplet size and of how the at least one component effects droplet size.

Another aspect of the present invention relates to a system which may include a first container having an agrochemical composition; a second container having a droplet control agent; and a third container in fluid communication with the first container and the second container. The system may include a fan nozzle sprayer fluidly connected to the third container. Alternatively, the system may include a jet nozzle sprayer fluidly connected to the third container. Additionally, the system may have a first pump system configured to pump the agrochemical composition from the first container to the third container; a second pump system configured to pump the droplet control agent from the second container to the third container; and a third pump system configured to spray a composition in the third container from the fan nozzle sprayer.

When using a fan nozzle sprayer, the system may additionally include at least one detector configured to detect at least one of: a droplet size, surface tension, a formation and/or collapse of a fan angle, and a spray footprint from the fan nozzle sprayer. Alternatively, when using a jet nozzle sprayer, the system may additionally include at least one detector configured to detect at least one: droplet wetting on a leaf, droplet size, surface tension, and droplet shatter or splash off from the jet nozzle sprayer. The system may also include a processor in communication with the at least one detector, the first pump system, the second pump system, and the third pump system and, in one aspect of the invention, the processor adjusts the ratio of the agrochemical composition and the droplet control agent in the third container to a predetermined droplet size.

### BRIEF DESCRIPTION OF DRAWINGS

FIG. 1 shows various droplet sizes when different components are added to sprayed compositions.

FIG. 2 shows change in droplet sizes when different components are added to sprayed compositions.

FIG. 3 shows a graph of surface tension of sprayed droplets over time.

FIG. 4 shows images of various spray footprinting.

FIG. 5 shows images of formation and collapse of fan angle during spraying.

FIG. 6 shows images of various wetting of sprayed compositions on leaves.

FIG. 7 shows various Volume Median Diameter (VMD) of sprayed composition.

FIG. 8 shows a graph of surface tension over time for various sprayed compositions.

FIG. 9 shows a schematic set-up for measuring droplet shatter of sprayed compositions.

FIG. 10 shows an image of a set up according to FIG. 9.

FIG. 11 shows the droplet shatter results for various compositions used in the apparatus of FIG. 10.

FIG. 12 shows images of the shatter results of sprayed compositions on a plant.

FIG. 13 shows images of the shatter results of sprayed compositions on a plant.

FIG. 14 compares an ideal spot spray to potential issues in spot spraying.

FIGS. 15A-15D show images and schematics related to the generation of a heatmap.

FIGS. 16A-16H show heatmaps generated by various spray systems.

FIG. 17 shows heatmaps generated by various spray systems.

FIGS. 18A and 18B quantify the heatmap results shown in FIGS. 16A-16H and 17.

FIGS. 19A and 19B show images of a system employing the methods disclosed.

FIG. 20 shows a flow diagram of a method of the disclosure.

FIG. 21 shows a flow diagram of a method of the disclosure.

FIG. 22A is the numerical output heatmap of an imaged filter paper that was sprayed with a test composition.

FIG. 22B is a heatmap generated from the numerical outputs in FIG. 21A.

### DETAILED DESCRIPTION

Before certain embodiments are described in greater detail, it is to be understood that this disclosure is not limited to certain embodiments described, as such may, of course, vary. It is also to be understood that the terminology used herein is for the purpose of describing certain embodiments only, and is not intended to be limiting, since the scope of the present disclosure will be limited only by the appended claims.

Described herein are several definitions. Such definitions are meant to encompass grammatical equivalents.

The use of “or” means “and/or” unless stated otherwise. Furthermore, the use of the terms “comprising,” “having,” “including,” as well as other forms, such as “includes” and “included,” are intended to be inclusive and mean that there may be additional elements other than the listed elements.

As used herein, the term “about” when referring to a measurable value such as an amount, a temporal duration, and the like, is meant to encompass variations. Such variations, however, are dependent on the specific component referred to and the context as understood by a person of ordinary skill in the art.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, representative illustrative methods, and materials are now described.

Each of the individual embodiments described and illustrated herein has discrete components and features which may be readily separated from or combined with the features of any of the other several embodiments without departing from the scope or spirit of the present disclosure. Any recited method can be carried out in the order of events recited or in any other order which is logically possible.

Embodiments of the disclosure can be practiced without any component not specifically mentioned in this disclosure.

Embodiments described herein may comprise, consist essentially of, or consist of the elements therein.

Unless otherwise stated are percentages are given as percentages by total weight and all embodiments and preferred features may be combined in any combination.

Embodiments of the disclosure are applicable to both real-time, on the fly adjustment of an agrochemical sprayer, as well as, development/optimization/certification of formulations for conventional sprayers.

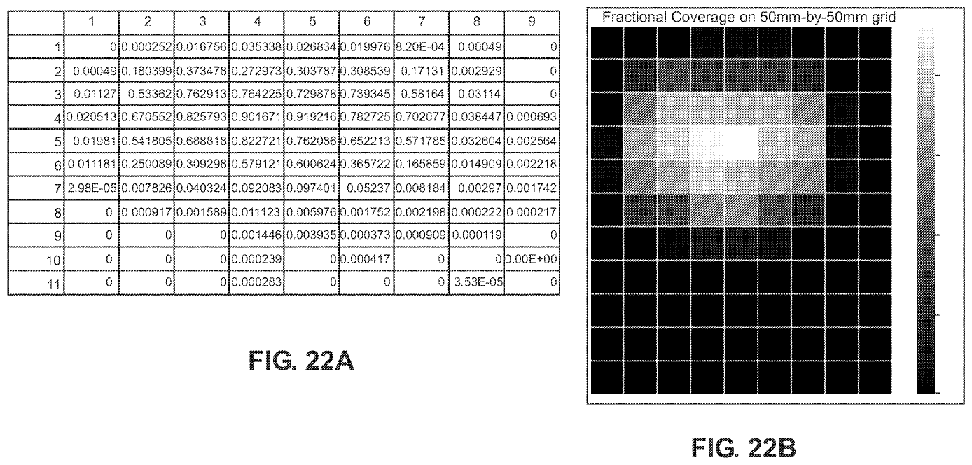

The term “heatmap” means a graphical representation of data that uses a system of color coding to represent different values, as used herein, the term heat map further includes representations of data which use numbers (e.g, FIG. 22A), symbols, letters, etc. Stated differently, heat maps, as used herein, are not limited to color codings, but can also use any type of representation which will allow a user to tell relative differences or absolute values. For example, the term “heat map” refers to any quantification or representation which provides relative amounts of components such as a quantification that, e.g., 50% of the agrochemical is in a target zone and 50% of the agrochemical is in an off-target zone. In some embodiments, zones within a heat map can have irregular shapes (not a square).

As used herein, the term “spray system” refers to both the mechanical spray system, e.g., nozzle and weed targeting system, but also the composition to be sprayed therefrom.

“PWM” refers to pulse width modulation, which is a way turning the spray on and off. The duty cycle associated with the PWN relates to the proportion of time that the nozzle is spraying during interval, e.g., a 100% duty cycle refers to being fully on for the interval.

“DRA” refers to drift reducing agent.

“OSS” refers to optical spot spraying.

“BC” refers to broadcast spraying.

The term “agrochemical” or equivalent terms include compounds or ingredients registered as being biologically active against an agricultural pest. In general, agrochemical active ingredients include compounds listed in: The Pesticide Manual, 12th edition, 2001, British Crop Protection Council. Agrochemicals include, but are not limited to herbicides, fungicides, other insecticides, bactericides, insect growth regulators, plant growth regulators, nematicides, molluscicides or mixtures of several of these preparations. In preferred embodiments, the agrochemical is an herbicide.

The term “agrochemically effective” or equivalent terms generally refer to approved rates of application of an agrochemical. An agrochemically effective amount is generally determined by the specific agrochemical and target thereof being used.

The rates of application of agrochemicals may vary within wide limits and depend on the nature of the soil, the method of application (pre-emergence; post-emergence; application to the seed furrow; no tillage application etc.), the crop plant, the weed(s) to be controlled, the prevailing climatic conditions, and other factors governed by the method of application, the time of application and the target crop.

Agrochemical compositions of the disclosure can have a sole active ingredient or can be admixed with one or more additional active ingredients. An additional active ingredient may, in some cases, result in unexpected synergistic activities.

The compositions of the disclosure may be employed in any conventional form, for example in the form of a twin pack, an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants. In general, such compositions are concentrates and diluted prior to use, however, composition can be provided in ready-to-use form (i.e., no dilution required).

Embodiments of the disclosure can include applying an agrochemical to a field.

Embodiments of the methods of spray calibration of the present invention can also include adjusting at least one component in the agrochemical composition 111 to increase or decrease the droplet size of the sprayed agrochemical composition 111 and/or include approving the agrochemical composition 111 for spraying. The spraying may be employed as part of a tractor system 100 or an aerial drone system 100. Additionally, the method of the present invention can include determining the droplet size by at least one of drop size distribution, volume median diameter, or any other means known to a person of ordinary skill in the art.

Drones, aerial and terrestrial, are generally known in the art. For example, drones for agricultural use are disclosed in U.S. Pat. Nos. 10,364,029; 11,144,059; 10,599,959; 9,382,003; and 9,563,852; US Patent Application Publications: 20220073205; 20170231213; 20160050840; 20160176542; 20170231213; 20180068164; and 20180068165. All of which are incorporated by reference in their entirety herein.

As used herein, agricultural equipment refers to equipment used in a field in relation to the production of crops. Drones and tractors, as described herein, are included as examples of agricultural equipment.

Precision agriculture equipment is also generally known in the art. For example, U.S. Pat. Nos. 11,445,658; 10,645,866; 10561059; 9,980,429 US Patent Application Publications: 20160253595; 20180359909; 20210112698; 20210059109; 20210307242. All of which are incorporated by reference in their entirety herein.

In general, the concentrate compositions include from 0.01 to 90% by weight of active agent, from 0 to 20% agriculturally acceptable surfactant and 10 to 99.99% solid or liquid formulation inerts and adjuvant(s). Concentrated forms of compositions generally contain in between about 2 and 80%, preferably between about 5 and 70% by weight of active agent.

Application forms of compositions can, for example, contain from 0.001 to 20% by weight, or preferably from 0.002 to 5% by weight of active agent. High precision application techniques may allow for higher concentrations of agrochemicals.

The term “safener” as used herein means a chemical that when used in combination with a herbicide reduces the undesirable effects of the herbicide on non-target organisms, for example, a safener protects crops from injury by herbicides but does not prevent the herbicide from killing the weeds. Compositions of the disclosure can include a safener. The following safeners are especially preferred: benoxacor, cloquintocet (including cloquintocet-mexyl), cyprosulfamide, dichlormid, fenchlorazole (including fenchlorazole-ethyl), fenclorim, fluxofenim, furilazole, isoxadifen (including isoxadifen-ethyl), mefenpyr (including mefenpyr-diethyl), metcamifen and oxabetrinil.

The agrochemical composition 111 can contain a droplet control agent 112, which is the component(s) in the agrochemical composition 111 used to increase or decrease the droplet size of the sprayed agrochemical composition 111. In another aspect of the invention, the method may include building a database of how the component(s) affects droplet size. Additionally, in another aspect of the invention, the method of spray calibration may include measuring at least one ambient condition selected from temperature, humidity, noise level, air quality, light intensity, pressure, or other ambient condition known to a person of ordinary skill in the art. Preferably, the method may include measuring at least two, at least three, at least four, at least five, or all of the above ambient conditions. The method may also adjust the at least one component in the agrochemical composition utilizes the database of how the ambient condition effects droplet size and of how the at least one component effects droplet size.

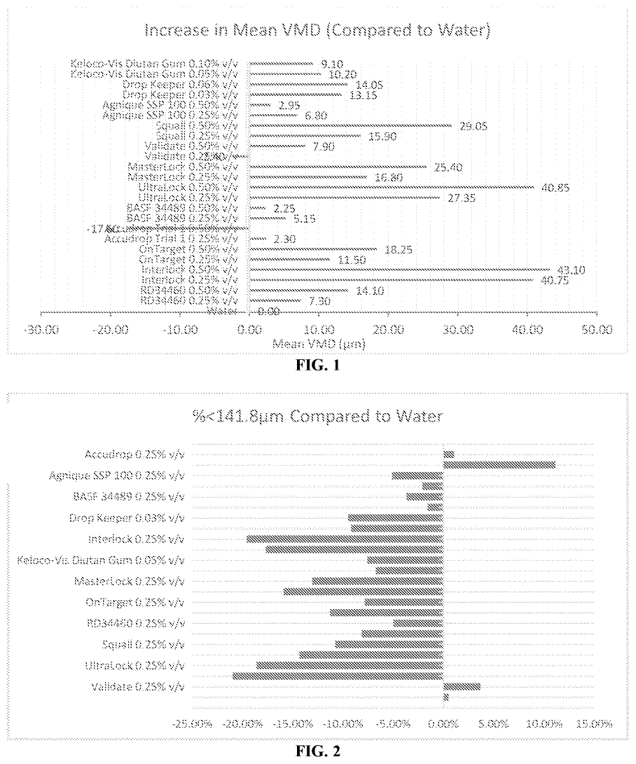

FIGS. 1-5 describe one embodiment of the disclosure involves a method of spray calibration which may include first spraying an agrochemical composition 111 from a fan sprayer and then determining from the spraying at least one of: a droplet size; surface tension; a formation and/or collapse of a fan angle; and a spray footprint. Preferably, the method may determine at least two of: a droplet size; surface tension; a formation and/or collapse of a fan angle; and a spray footprint. More preferably, the method may determine at least three of: a droplet size; surface tension; a formation and/or collapse of a fan angle; and a spray footprint. Even more preferably, the method may determine all of: a droplet size; surface tension; a formation and/or collapse of a fan angle; and a spray footprint.

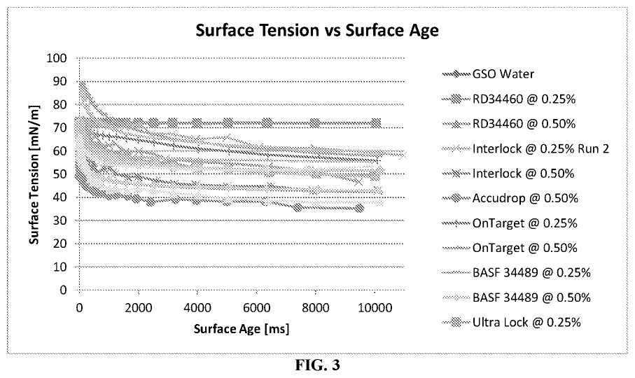

For example, using a fan sprayer such as a Lechler 2001 nozzle, droplet sizes were determined with Oxford Lasers of various compositions containing a droplet control agent. Each composition contained a full rate and half rate of the droplet control agent. Approximately 10,000 droplets were collected for each run. The results are provided in FIG. 1 and FIG. 2.

In another example, dynamic surface tension measurements were taken using samples directly sprayed from the nozzle. Again, the compositions tested at both full and half rate of each droplet control agent. The results are provided in FIG. 3.

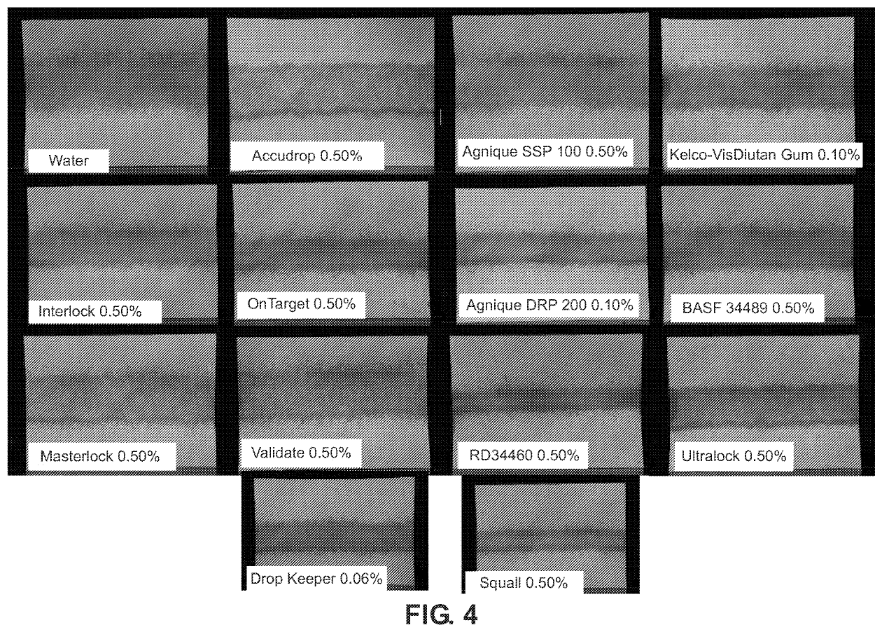

In another example, spray Footprinting was taken from each composition as shown in FIG. 4. The nozzle tip to target was 20 inches at 35 psi. Spray Footprinting includes spraying from a fan nozzle while the nozzle moves parallel to the spray surface. The spray surface can be an absorptive material.

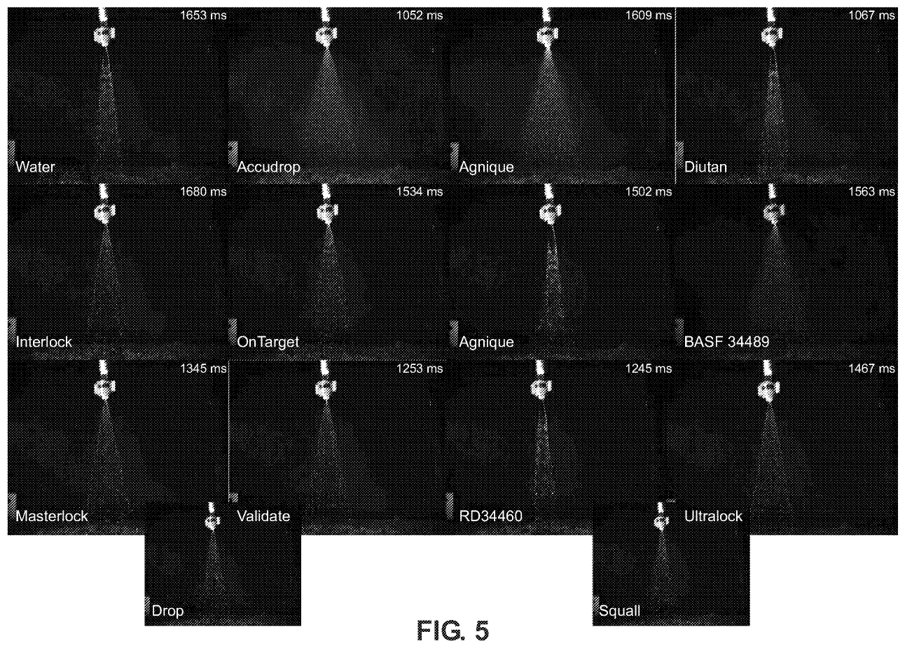

In another example, A high-speed camera was used to view the formation and collapse of fan angle as shown in FIG. 5. The images can be used to evaluate spray quality.

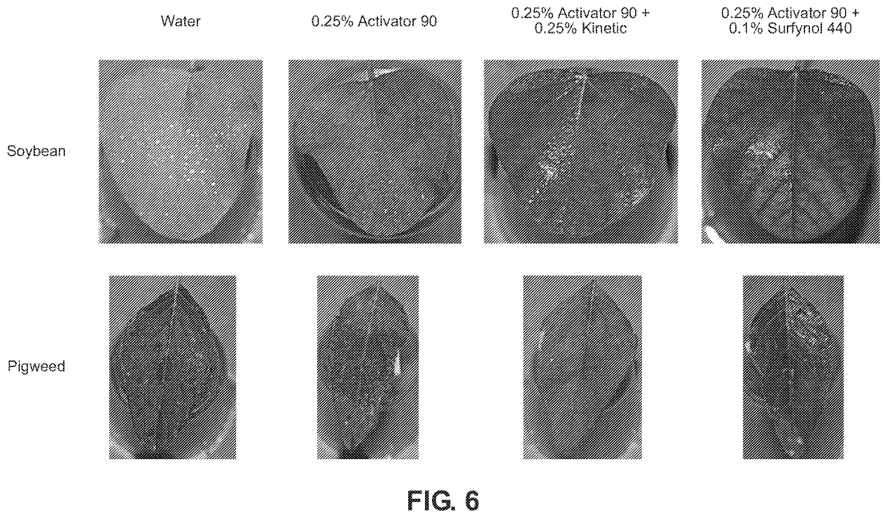

FIGS. 6-13 disclose an alternative embodiment of the method of spray calibration. As such, the method of spray calibration may include first spraying an agrochemical composition 111 from a jet sprayer and then determining from the spraying at least one of: droplet wetting on a leaf; a droplet size; surface tension; and droplet shatter or splash off. Preferably, the method may determine at least two of: droplet wetting on a leaf; droplet size; surface tension; and droplet shatter or splash off. More preferably, the method may determine at least three of: droplet wetting on a leaf; droplet size; surface tension; and droplet shatter or splash off. Even more preferably, the method may determine all of: droplet wetting on a leaf; droplet size; surface tension; and droplet shatter or splash off. Similar to the examples above, wetting of various compositions were tested on soybean leaves and pigweed leaves, the results are shown in FIG. 6.

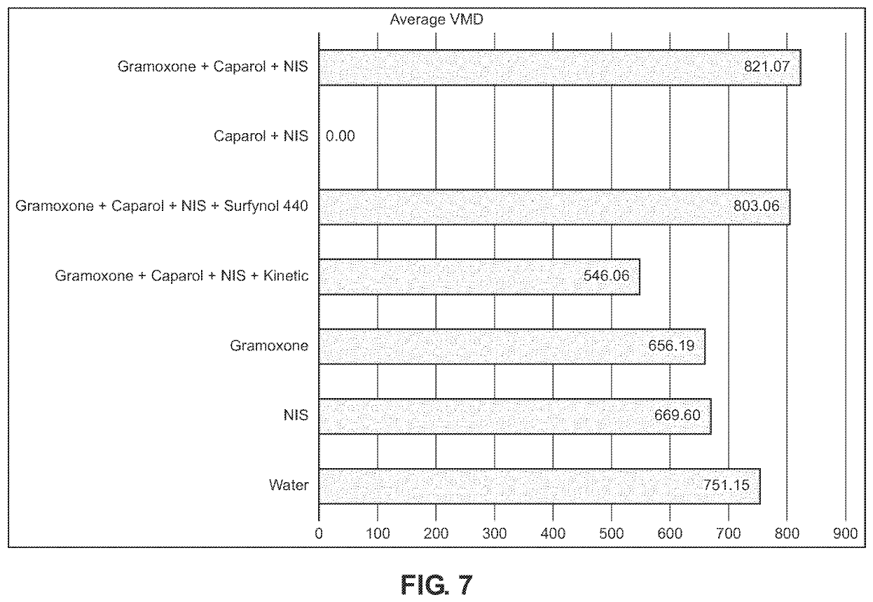

Drop size distribution (DSD) measurements were taken from sprayed composition. The results are provided in FIG. 7.

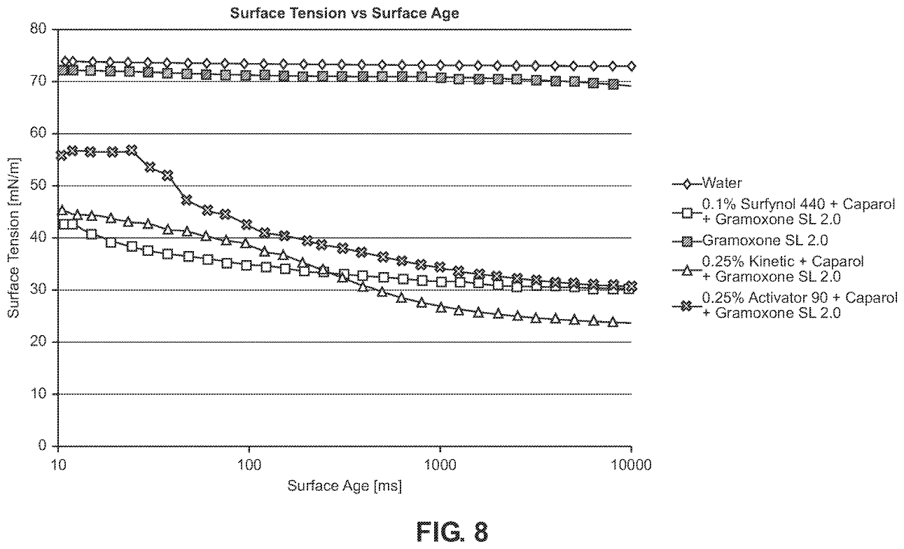

Surface tension of sprayed formulations were measured over time. The results are provided in FIG. 8.

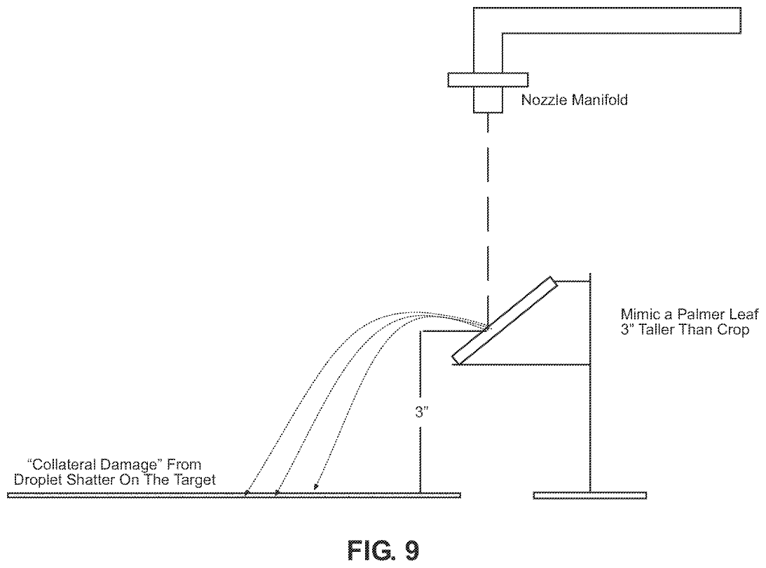

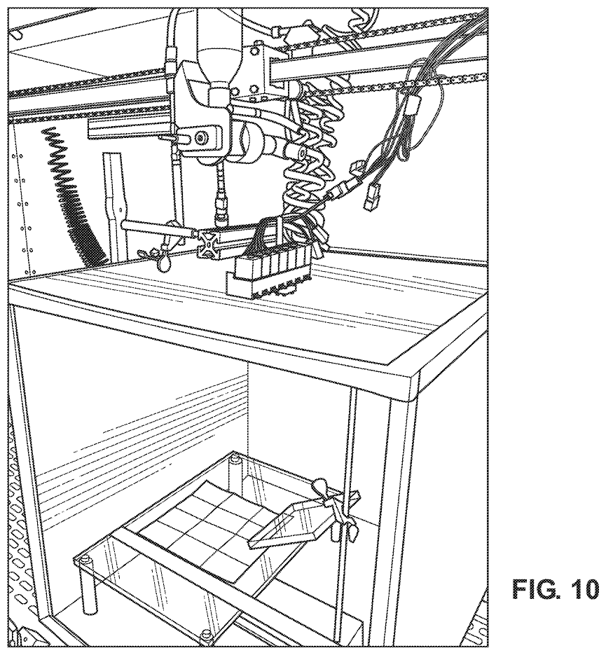

A testing apparatus was set up as shown in the schematic of FIG. 9, and image of FIG. 10. Compositions were sprayed at the mimic leaf using the following parameters:
Spray Volume is 59 gpa
Pressure is at 20 psi
Height below nozzle is 16″
Height difference between target and WSP 3″
Angle of acrylic remained constant at 34°
Volume per “trigger” is 0.055 mL.

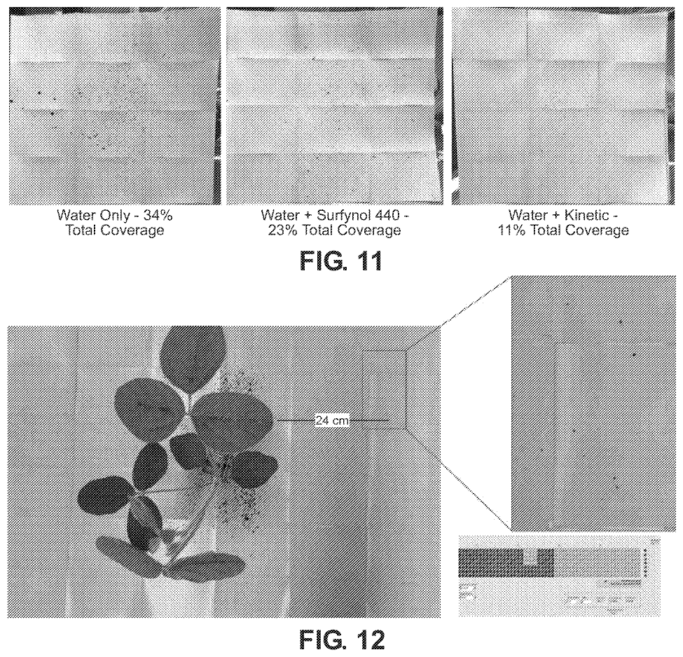

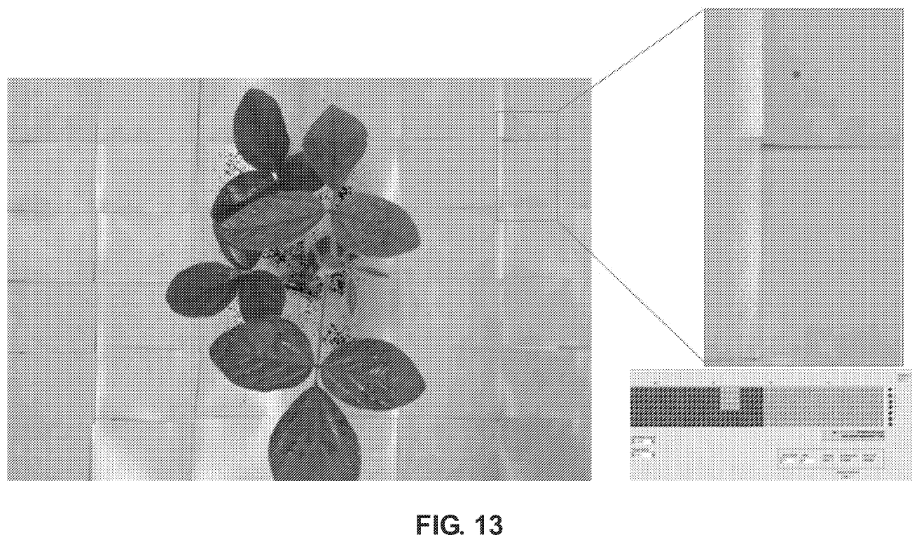

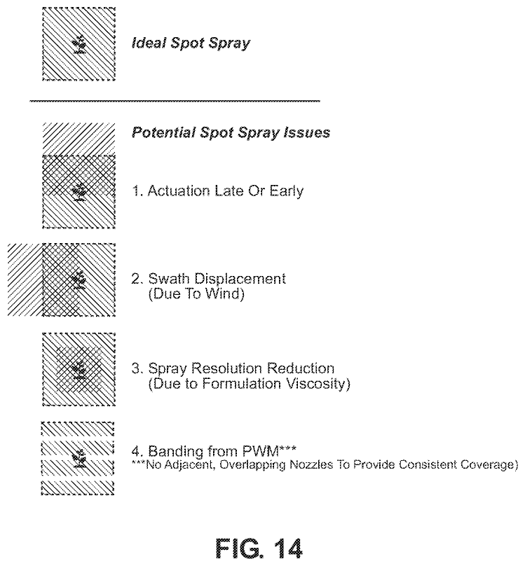

The results of three tests are provided in FIG. 11. Improvements in splash off were seen when adding the additives to the tank mix. It was noted that kinetic outperforms with a reduction of splash off by 23%. With the assumption that water only will perform similarly to the Garmoxone+Caparol mixture.

Tests were repeated again on plants. FIG. 12 shows the results of a spray composition with water+0.25% surfynol 440, and FIG. 13 shows the results of water +0.25% Kinetic.

Another embodiment of the disclosure includes a method for selecting a nozzle-agrochemical combination to perform at least one of reducing at least one of resistance development in a pest species, reducing phytotoxicity in a crop plant, maximizing effective dose, and reducing off target effects. The method may include obtaining a target area having a target zone and an off-target zone and spraying for a time (T), a volume (V), of a liquid composition through a test nozzle, at a height (H) from the test nozzle to the target surface, and at the target zone of the target surface. Further, the method may include measuring at least one of: the amount of the liquid composition in the target zone, and the amount of the liquid composition in the off-target zone; and producing a heat map of at least one of: the measured amount of the liquid composition in the target zone, and the measured amount of the liquid composition in the off-target zone.

In embodiments of the disclosure, the test nozzle moves parallel to the surface of the target surface. Such movement simulates an on-the-go vehicle, as is common with wheeled vehicles, e.g., tractors or flying drones. In specific embodiments, the parallel movement is achieved by attachment of the nozzles, and spray system therefor, to the wheeled vehicle or flying drone. In some embodiments it is more efficient to simulate such movement, however, it may also be advantageous to include the nozzle and spray system on the wheeled vehicle or flying drone to mirror real-world conditions more closely.

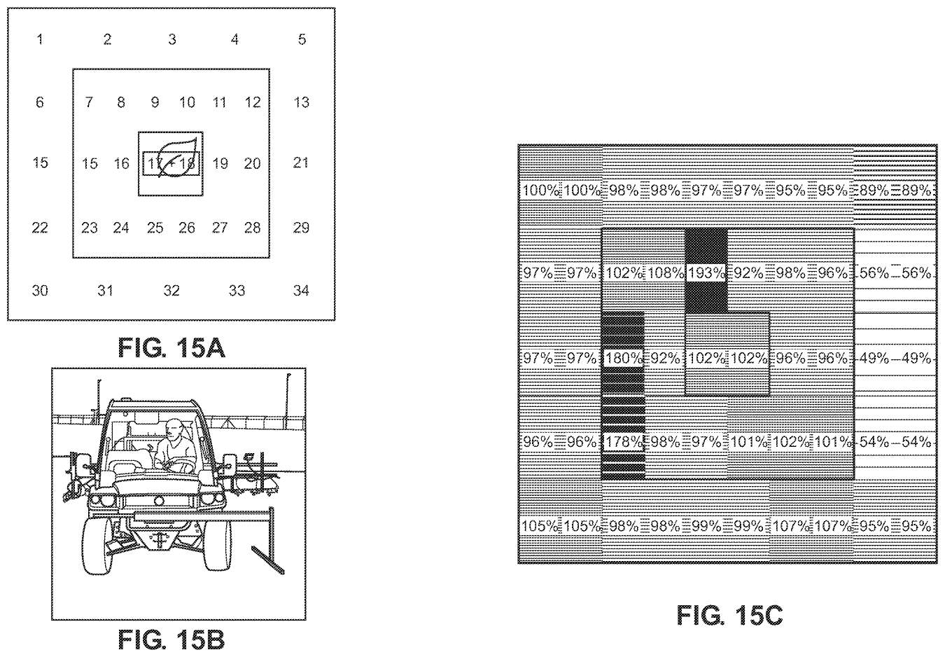

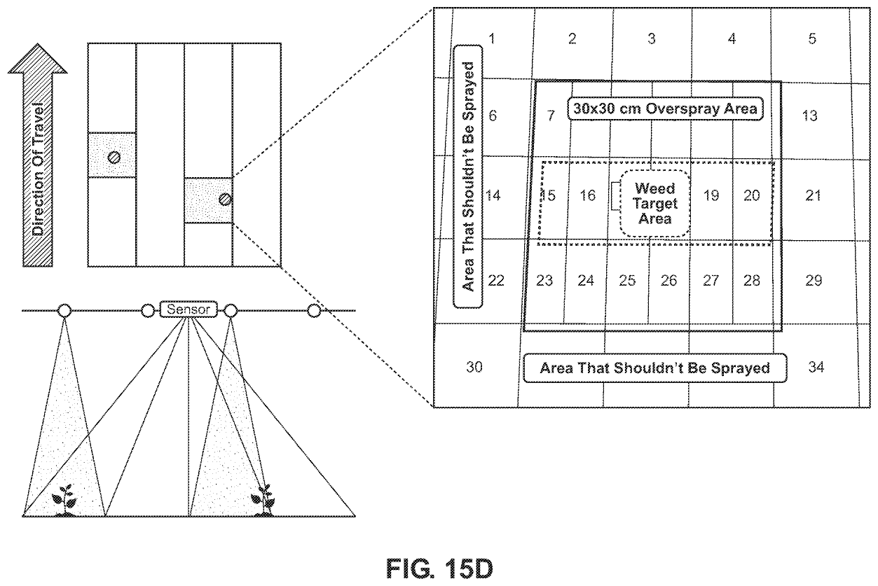

When the nozzle is traveling, as in FIG. 15D, the typical speed can be 1 to 15 miles per hour, preferably 1 to 10 miles per hour, and more preferably 2 to 7 miles per hour. Further, the height of the nozzle may vary depending on the specific application. For example, nozzle heights may be greater in aerial drone applications, whereas a mini-wheeled-vehicles may contain nozzle closer to the ground. Nozzle height refers to the height of the nozzle from the ground or surface on which the target, or triggering object, sits. Height (H) can be from 1 to 100 inches, preferably 2 to 75 inches, more preferably 4 to 50 inches, or even 10 to 25 inches.

In preferred embodiments, the target zone includes a triggering object such as a plant, a plant part, an object designed to mimic a plant or a plant part. In specific embodiments the triggering object is a crop, or representative thereof, in alternative embodiments, the triggering object is a pest, e.g., a weed. Further, detecting the triggering object within the target zone may trigger the spraying of the target area. To this end, spraying systems of the disclosure can include a variety of pest detection systems as known in the art. Such systems can include a variety of sensing systems, e.g. light detection and ranging (LIDAR), cameras, etc. Such sensing systems can further be in communication with various information processing systems, such as computers, which classify sensed objects and issue commands to the nozzle system, such as when and how to spray.

In addition to analyzing spray concentrations in a target zone, it may be additionally advantageous to establish an off-target zone which surrounds the target zone. For example, depending on the triggering object, the off-target zone can include crops for which it is not desirous to have agrochemical compositions come in contact with. In specific embodiments the target zone has a surface area (TZSA) in the range of 1-1000 cm², 2-500 cm², 4-200 cm², 10-100 cm², or even 15-50 cm² depending on the specific triggering object and. In general, the off-target zone has a surface area at least 5× TZSA, 4× TZSA, 3× TZSA, 2× TZSA, 1× TZSA, 0.5× TZSA, or even 0.25× TZSA. In specific embodiments, the off-target zone has a surface area in the range of 2 to 15× the TZSA, 1 to 10× the TZSA, 0.5 to 7× the TZSA, or even 0.25 to 5× the TZSA.

In specific embodiments, the liquid composition may further comprise a visualization additive, such as an ultraviolet (UV) tracer dye. However, the sprayed compositions do not need to include a UV tracer. Other visualization additives including other dyes will be understood to a person of ordinary skill in the art. For example, rather than using a spectrophotometer, an agrochemical on the filter paper can be extracted, and the resulting formulation quantified by known methods, e.g., a chromatograph.

As such, the target zone can include at least one layer of filter paper or other material or vessel which can collect spray droplets. However, filter paper may not be necessary depending on the sensing equipment and information processing systems. The target area can include both visual and/or simulated grid lines. The grid lines may be used to divide various target zones and off-target zones into specific areas of analysis. Each of the divided grid zones or areas of analysis can also be considered a target zone or off-target zone. In such cases, the target zone can include a plurality of sub-target zones and/or off-target zones.

Further, measuring the amount of liquid composition may include quantifying the amount of UV tracer dye or other additive in the off-target zone and/or the target zone. The target zone may also include a plurality of sub-target zones. Additionally, the method may be repeated with a second liquid test composition and/or with a different test nozzle as disclosed herein. Preferably, the second test composition may be identical to the composition except for the addition or removal of at least one adjuvant, such as a droplet control agent. Further, the method may include blowing air over the target surface. Finally, the method may include selecting a nozzle-chemical combination having at least one of a desired amount of the test chemical in the target zone, and a desired amount of the test chemical in the off-target zone.

In some embodiments, methods include repeating and/or comparing the method with different compositions and/or with different test nozzles and/or different spray systems. In specific embodiments, sprayed compositions may differ in only the addition or reduction of at least one adjuvant and/or at least one DRA. Such examples of adjuvants and DRAs used in the present embodiments of the disclosure include but are not limited to AccuDrop®, Agnique® SSP 100, Kelco-Vis® dituan gum, DropKeeper, Squall, Validate, masterLock, UltraLock, BASF 34489, OnTarget, Interlock, RD34460, and nonionic surfactants (NIS) such as Kinetic® and Surfynol® 440.

In certain embodiments, air may be blown over the target surface. Further, a specific embodiment of the disclosure includes selecting for agricultural use, a nozzle-chemical combination having at least one of (a) a desired amount of the test chemical in the target zone, and (b) a desired amount of the test chemical in the off-target zone.

For example, to produce a heat map, a grid was prepared on 0.5×0.5 m filter paper, as shown in FIG. 15A. Squares 17 and 18 reflect the target area. The box outlining first target zone is a second target zone, and the area outside the second target zone is a third target zone or non-target zone. A vehicle was equipped with a spray system and targeting systems for identifying targets, e.g., a triggering object, as show in FIG. 15B. The vehicle and spray system were run with a test spray composition having a blue UV tracer dye, a schematic of the system is provided in FIG. 15D. The filter paper was reviewed: (1) visually; (2) under a UV light; and (3) sections of the filter paper were separated into sections and the tracer was wash off tracer into a test tube where the amount of tracer in the test tube was quantified with a spectrophotometer. Finally, a heat map was created to visualize the dye per section, as shown in FIG. 15C:

$$\begin{matrix}Grey = 100 \% rate or 1 x rate \\ Blue = greater than 100 \% or 1 x rate [ over apply ] \\ Red = less than 100 \% or 1 x rate [ under apply ]\end{matrix}$$

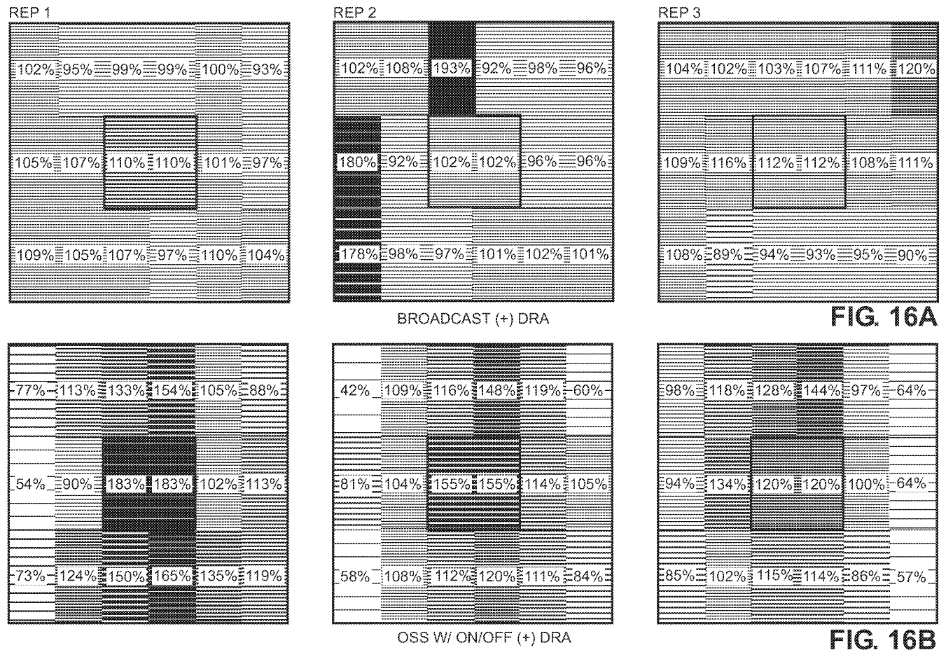

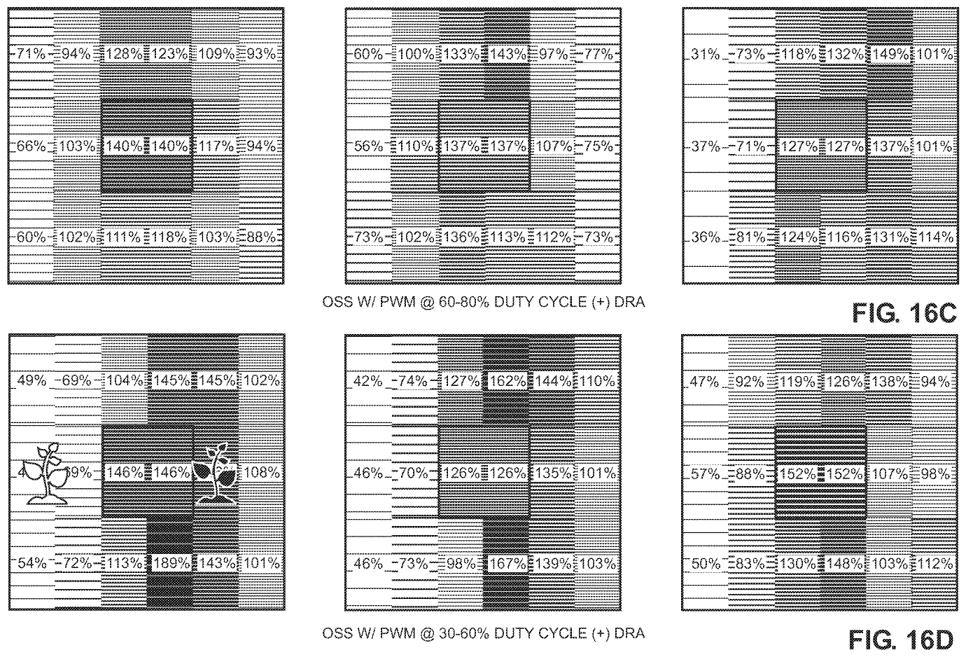

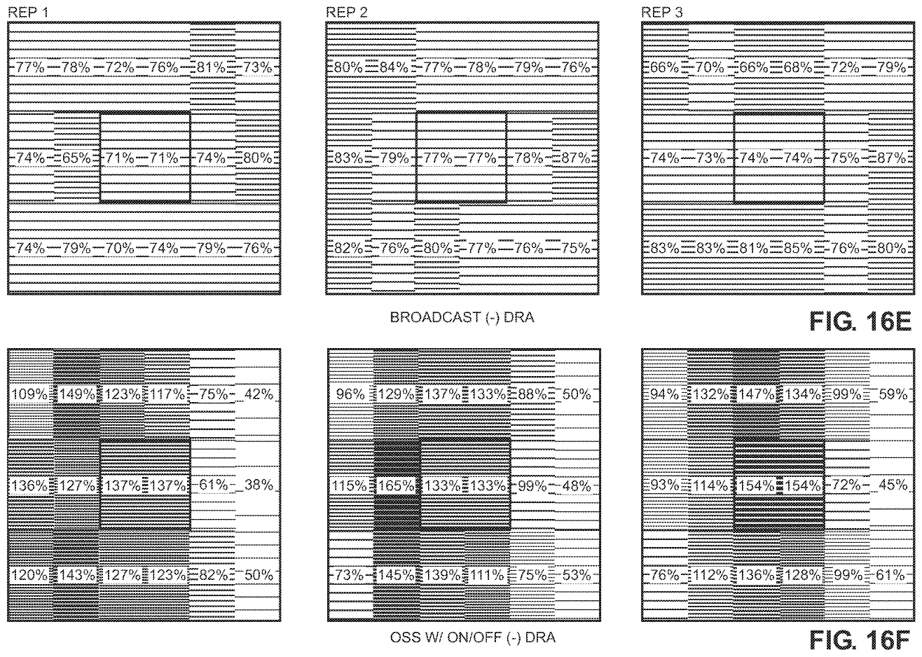

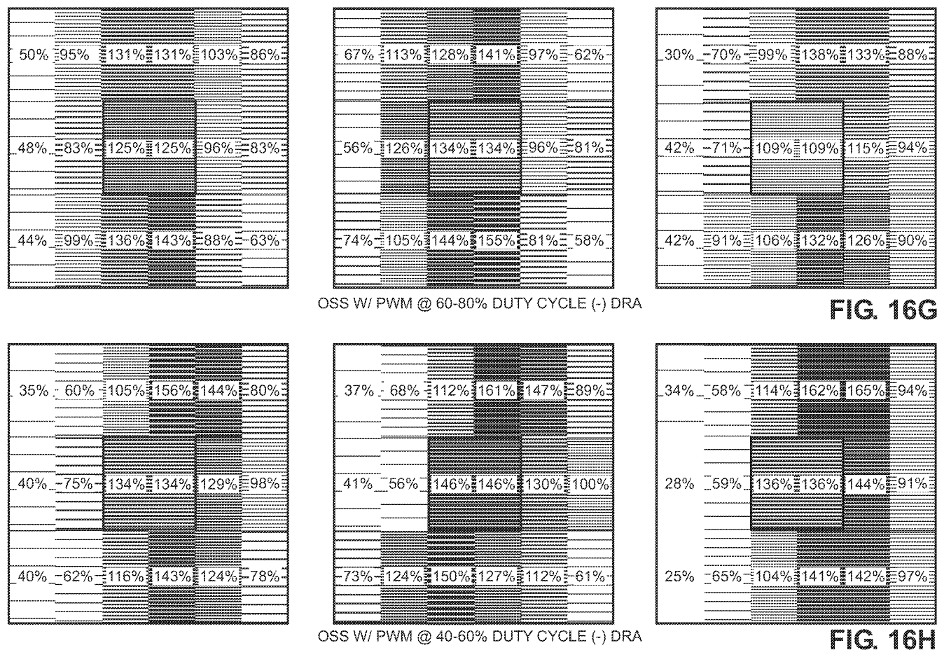

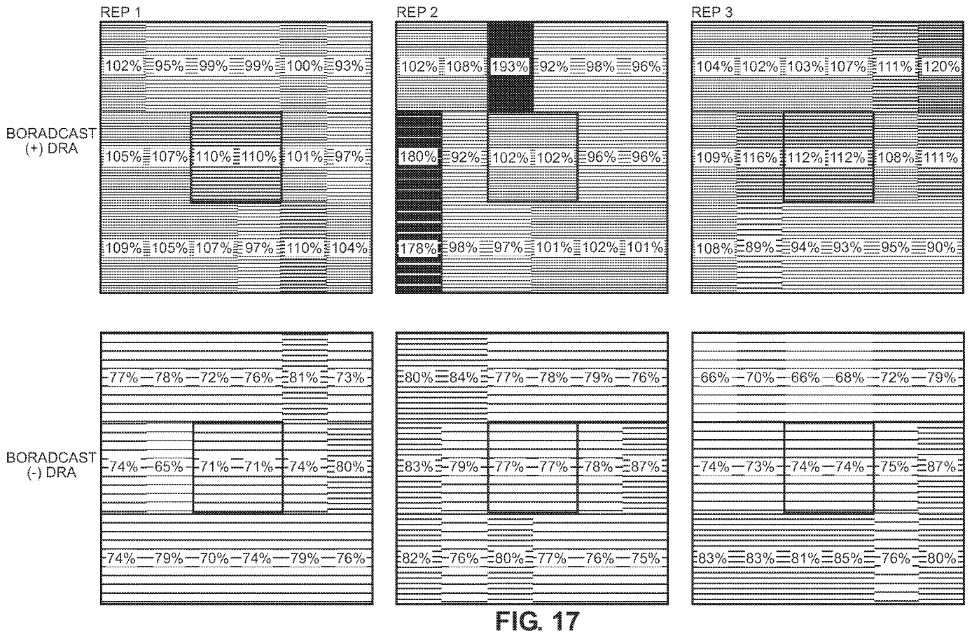

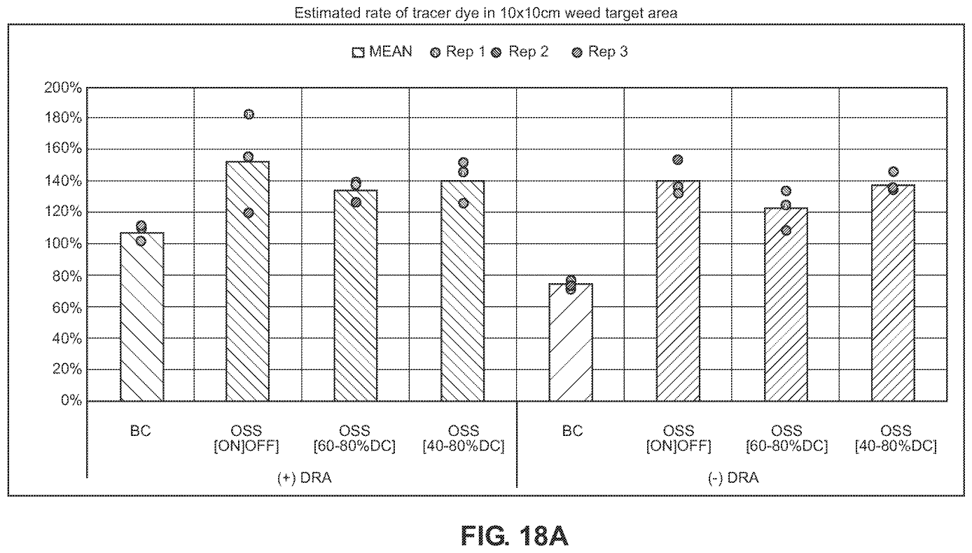

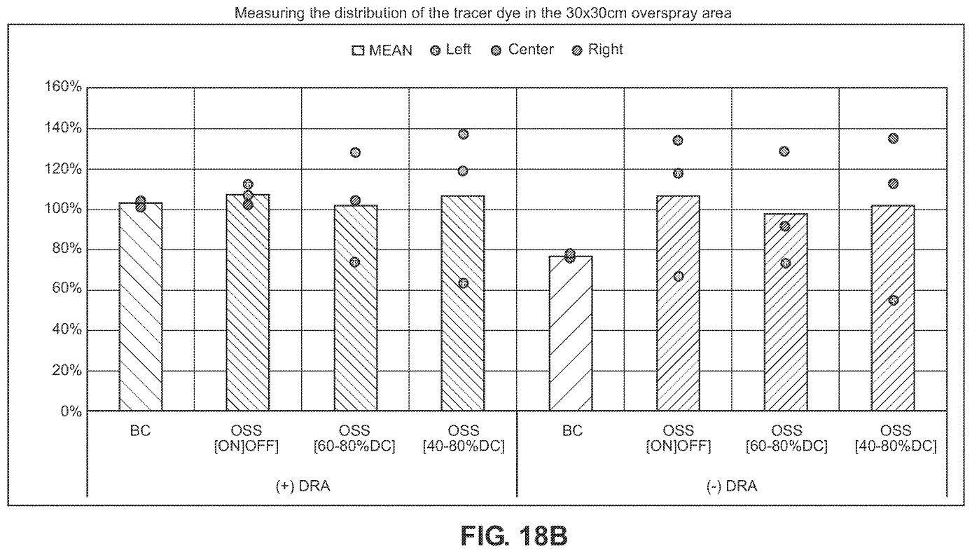

The system was run on under multiple conditions to evaluate various spray techniques with the results provided in FIGS. 16A-16H and 17. FIGS. 18A and 18B show further quantification of spray distribution in the central 10×10 area and 30×30 area, respectively.

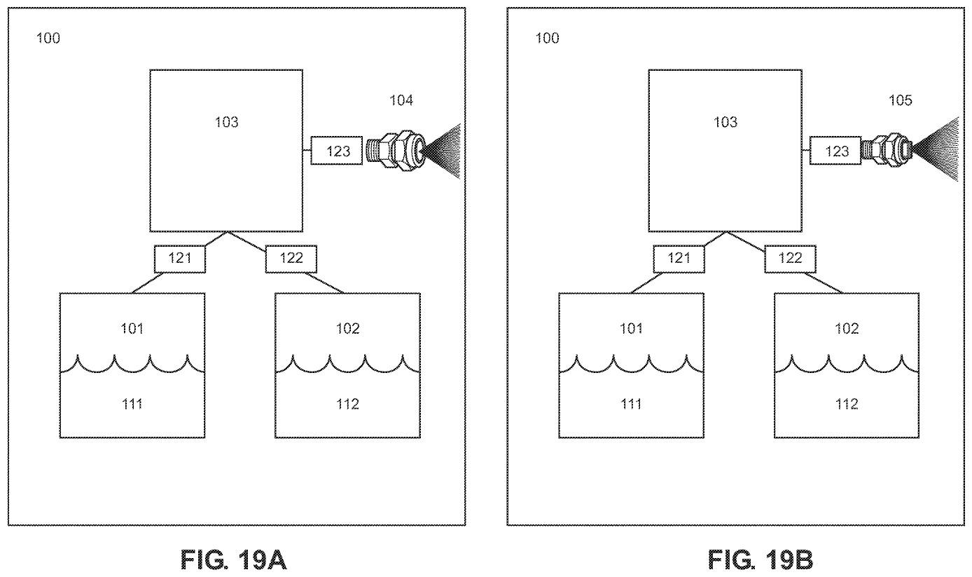

The disclosure also describes an embodiment of a system 100 to be used with the embodiments described above, seen in FIGS. 19A and 19B. This system 100 may include a first container 101 having an agrochemical composition 111; a second container 102 having a droplet control agent 112; and a third container 103 in fluid communication with the first container 101 and the second container 102. The system 100 may include a fan nozzle sprayer 105 fluidly connected to the third container 103. Alternatively, the system 100 may include a jet nozzle sprayer 104 fluidly connected to the third container 103. Additionally, the system 100 may have a first pump system 121 100 configured to pump the agrochemical composition 111 from the first container 101 to the third container 103; a second pump system 122 100 configured to pump the droplet control agent 112 from the second container 102 to the third container 103; and a third pump system 123 100 configured to spray a composition in the third container 103 from the fan nozzle sprayer 105 or, alternatively, the jet nozzle sprayer 104.

When using a fan nozzle sprayer 105, the system 100 may additionally include at least one detector configured to detect at least one of: a droplet size, surface tension, a formation and/or collapse of a fan angle, and a spray footprint from the fan nozzle sprayer 105. Alternatively, when using a jet nozzle sprayer 104, the system 100 may additionally include at least one detector configured to detect at least one: droplet wetting on a leaf, droplet size, surface tension, and droplet shatter or splash off from the jet nozzle sprayer 104. The system 100 may also include a processor in communication with the at least one detector, the first pump system 121 100, the second pump system 122 100, and the third pump system 123 100 and, in one aspect of the invention, the processor adjusts the ratio of the agrochemical composition 111 and the droplet control agent 112 in the third container 103 to a predetermined droplet size.

The present technology allows for determination of a nozzle, formulation combination which provides optimum droplet size and further which can maximize the amount of droplets that hit the target with coverage and efficacy.

The above techniques for measuring jet spraying, nozzle spraying, and generating a heat map can be combined mutatis mutandis.

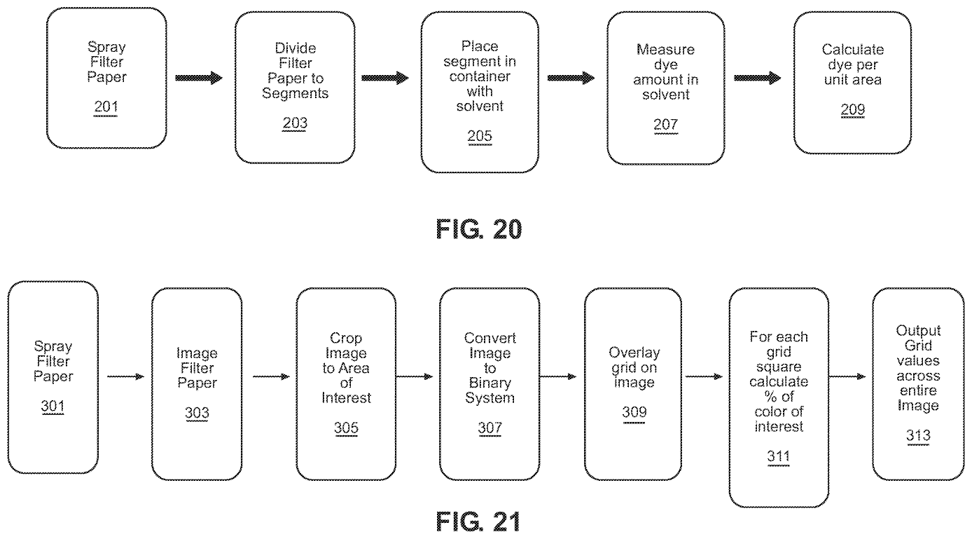

Embodiments of the disclosure are further illustrated in the flow diagrams of FIGS. 20 and 21.

The diagram of FIG. 20 can be considered in two parts. Step 201 and 203 refer to a spray capture phase, and steps 205, 207, and 209 refer to a dye wash off phase.

In Step 201, spraying filter paper, can further include adding fluorescent dye to spray solution, loading spray solution into a tracksprayer, setting the tracksprayer with one or more desired conditions, marking filter paper with a grid, laying target filter paper in line with the track sprayer, and spraying the target paper. In step 203, dividing the filter paper into segments including separating the filter paper based on the pre-drawn grid.

In step 205, placing a segment of the filter paper in container with solvent can further includes the steps of adding a known amount of a suitable solvent to the contains, and agitating the container for a set amount of time.

In step 207, measuring the dye amount in the solvent, further steps can include, a subsample wash off of solvent and dye into test-tube, placing the test tube into a calibrated fluorimeter, and recording a value (e.g., μg/L) of tracer/dye in solution.

In step 209, calculating tracer per unit area, can further include calculating the amount of tracer present based on a known amount of solvent, calculating tracer per unit area based on the known area of the filter, and calculating the total amount of tracer deposited on the washed off area based on the known concentration of tracer.

The diagram of FIG. 21 represents a method of the disclosure which utilizes image processing to generate a heatmap. The diagram of FIG. 21 can be considered in two parts, where steps 301 and 303 represent an image capture phase, and steps 305, 307, 309, 311, and 313 represent image processing for the heat map.

In step 301, spraying the filter paper, can include adding a dye/tracer to a spray solution, loading the spray solution into a tracksprayer, setting up the tracksprayers with at least one desired condition, placing calibration lines on filter paper, laying the filter paper in line with the track sprayer, and spraying the target paper.

In step 303, imaging the filter paper, can include placing filter paper on an imaging bed, setting up a camera and optionally lighting, and imaging the filter paper such that the entire paper is captured.

In step 305, cropping the image to an area of interest, can include defining parameters (e.g., image location, grid size, scale line length, k-means segments and graph colour scheme), selecting points around the system to be cropped, and setting up a scale of the system by using a line of known length drawn on the paper.

In step 307, converting the image to a binary system, includes converting colours using k-means (preferably 4 segments using clustering) or other methods of clustering such as imageJ thresholding.

In step 309, overlaying a grid on the image, includes overlaying a user defined grid on the image, and when the cropped image dimension does not align with grid, the last grid row/column is treated as a whole grid.

In step 311, calculating % color of interest, can include, based on k-means differentiation of color, calculating for prominent k-means segment, the fraction of the number of pixels in a given grid square from that k-means segment.

In step 313, outputting grid values across the entire image, can include outputting grid values to a csv file and producing a graphical representation of data based on a user defined color scheme.

FIGS. 22A and 22B illustrate a heat generated using the procedure of FIG. 21. The image was processed to include a 9×11 user-defined grid, with the numerical output in each grid corresponding to the % of color of interest contained within each grid. The target zone may be considered to be grids 4,5; 5,5; 4,6; and 5,6 (x,y coordinates).

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

1. A method for selecting a nozzle-agrochemical combination to perform at least one of reducing resistance development in a pest species, reducing phytotoxicity in a crop plant, maximizing effective dose, and reducing off target effects, the method comprising:
obtaining a target area having a target zone and an off-target zone;
spraying for a time (T), a volume (V), of a liquid composition through a test nozzle, at a height (H), at the target zone of the target surface;
measuring at least one of:
the amount of the liquid composition in the target zone, and
the amount of the liquid composition in the off-target zone;
producing a heat map of at least one of:
the measured amount of the liquid composition in the target zone, and
the measured amount of the liquid composition in the off-target zone.

2. The method of claim 1, wherein the test nozzle moves parallel to the surface of the target surface.

3. The method of claim 2, wherein the test nozzle is traveling at a speed of 2 to 7 miles per hour.

4. The method of claim 1, wherein His from 4 to 50 inches.

5. The method of claim 1, wherein the target zone includes a triggering object.

6. The method of claim 4, wherein the triggering object is a plant, a plant part, or an object designed to mimic a plant or a plant part.

7. The method of claim 6, wherein detecting the triggering object within the target zone triggers the spraying.

8. The method of claim 1, wherein the off-target zone surrounds the target zone.

9. The method of claim 1, wherein the target zone has a surface area (TZSA) in the range of 4-200 cm².

10. The method of claim 9, wherein the off-target zone has a surface area at least 2× TZSA.

11. The method of claim 9, wherein the off-target zone has a surface area in the range of 2 to 15× the TZSA.

12. The method of claim 1, wherein the target zone includes at least one layer of filter paper.

13. The method of claim 11, wherein the target area includes grid lines.

14. The method of claim 11, wherein the liquid composition further comprises a visualization additive.

15. The method of claim 14, wherein the visualization additive includes at least one of a dye or a UV tracer dye.

16. The method of claim 15, wherein measuring includes quantifying the dye.

17. The method of claim 1, wherein the target zone comprises a plurality of sub-target zones.

18. The method of claim 1, further comprising repeating with a second test composition and/or with a different test nozzle.

19. The method of claim 18, wherein the second composition is identical to the composition but for the addition or reduction of at least one adjuvant.

20. The method of claim 1, further comprising blowing air over the target surface.

21. The method of claim 1, further comprising selecting for agricultural use, a nozzle-chemical combination having at least one of
a desired amount of the test chemical in the target zone, and
a desired amount of the test chemical in the off-target zone.

22. The method of claim 1, wherein producing the heat map includes a representation indicating excess spray, target spray, or below spray concentrations.

23. The method of claim 1, wherein the heatmap is a digital output.

24. The method of claim 23, wherein the measuring further comprises imaging the target zone and the off-target zone.

25. The method of claim 24, wherein the measuring further comprises converting the imaging of the target zone and the off-target zone to a binary system.

26. The method of claim 25, wherein the measuring further comprises calculating a percent representation of spray droplets based on a k-means differentiation.

27. The method of claim 26, outputting a graphical representation based on the calculating the percent representation for both the target zone and the off-target zone.
